(19) United States
(12) Patent Application Publication
(10) Pub. No.: US 2025/0190806 A1
(43) Pub. Date: Jun. 12, 2025

(54) MACHINE LEARNING TECHNIQUES FOR PREDICTING AND RANKING SUGGESTIONS BASED ON USER ACTIVITY DATA

(71) Applicant: UnitedHealth Group Incorporated, Minnetonka, MN (US)

(72) Inventors: Ayush Tomar, Morgan Hill, CA (US); Chenwei Liu, Rockville, MD (US)

(21) Appl. No.: 18/532,510

(22) Filed: Dec. 7, 2023

(51) Int. Cl. G06N 3/09; G06N 3/0455

(52) U.S. Cl. CPC G06N 3/09; G06N 3/0455

(57) ABSTRACT

Various embodiments of the present disclosure provide methods, apparatus, systems, computing devices, computing entities, and/or the like for providing content item suggestions based on historical search data of a user by: generating one or more content item feature vectors associated with a plurality of content items from a list of suggestions, generating one or more personalized feature vectors associated with the user based on user activity data, generating a plurality of predictions for the plurality of content items based on the one or more keyword feature vectors and the one or more personalized feature vectors, assigning a plurality of rankings to the plurality of content items based on the plurality of prediction probabilities, and generating one or more suggestions based on the plurality of rankings.

### BACKGROUND

Various embodiments of the present disclosure address technical challenges related to predictive data analysis and provide solutions to address the efficiency and reliability shortcomings of existing predictive data analysis solutions.

Traditionally, the effectiveness of a search engine associated with an information retrieval system may be measured based on a percentage of users who transact with an entity after navigating to a search result associated with the entity, or a percentage of users who transact with an entity after being directed to a content item associated with the entity. Existing predictive data analysis solutions may have low conversion rates (e.g., a rate users that transact with an entity after completing a search) because they rely on search algorithms that output search result that may be relevant to a search query, but are not relevant to a user or are not capable of navigating a user to a relevant content item. Even if relevant search results are provided, content items suggested by traditional information retrieval system are not optimized for cost, quality of service, and ratings, such that relevant search results may accurate, but not favorable for user.

Various embodiments of the present disclosure make important contributions to traditional model evaluation techniques by addressing these technical challenges, among others.

### BRIEF SUMMARY

In general, various embodiments of the present disclosure provide methods, apparatus, systems, computing devices, computing entities, and/or the like for surfacing improved content item suggestions.

Various embodiments of the present disclosure make important technical contributions to predictive analysis that address the efficiency and reliability shortcomings of existing predictive analysis solutions. As described herein, identifying user query intention and assisting users in finding more relevant and favorable content items (e.g., to facilitate transactions with entities providing goods or services desired by the users) may improve information retrieval quality. Some of the techniques of the present disclosure leverage improved embeddings that encode a personalized relevancy for a user by merging features of content items and user activities. This, in turn, allows for improved performance of various predictive operations, such as the generation of keyword suggestions, typeahead suggestions, search results and/or the like.

In some embodiments, a computer-implemented method comprises receiving, by one or more processors, a list of suggestions that comprises a plurality of content items associated with a plurality of entities; generating, by the one or more processors, a plurality of content item feature vectors associated with the plurality of content items; generating, by the one or more processors, one or more personalized feature vectors based on activity data associated with a user; generating, by the one or more processors, a plurality of predictions for the plurality of content items based on the plurality of content item feature vectors and the one or more personalized feature vectors; assigning, by the one or more processors, a plurality of rankings to the plurality of content items based on the plurality of predictions; and generating, by the one or more processors, one or more suggestions, responsive to a search input received from the user, by selecting one or more of the plurality of content items based on the plurality of rankings.

In some embodiments, a computing system comprising memory and one or more processors communicatively coupled to the memory, the one or more processors configured to receive a list of suggestions that comprises a plurality of content items associated with a plurality of entities; generate a plurality of content item feature vectors associated with the plurality of content items; generate one or more personalized feature vectors based on activity data associated with a user; generate a plurality of predictions for the plurality of content items based on the plurality of content item feature vectors and the one or more personalized feature vectors; assign a plurality of rankings to the plurality of content items based on the plurality of predictions; and generate one or more suggestions, responsive to a search input received from the user, by selecting one or more of the plurality of content items based on the plurality of rankings.

In some embodiments, one or more non-transitory computer-readable storage media including instructions that, when executed by one or more processors, cause the one or more processors to receive a list of suggestions that comprises a plurality of content items associated with a plurality of entities; generate a plurality of content item feature vectors associated with the plurality of content items; generate one or more personalized feature vectors based on activity data associated with a user; generate a plurality of predictions for the plurality of content items based on the plurality of content item feature vectors and the one or more personalized feature vectors; assign a plurality of rankings to the plurality of content items based on the plurality of predictions; and generate one or more suggestions, responsive to a search input received from the user, by selecting one or more of the plurality of content items based on the plurality of rankings.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for generating suggestions for search input in accordance with some embodiments of the present disclosure.

FIG. 5 is a flowchart diagram of an example process for assigning rankings to content items in accordance with some embodiments of the present disclosure.

FIG. 6 is a flowchart diagram of an example process for generating training data in accordance with some embodiments of the present disclosure.

FIG. 7 is an operational example of a personalized re-ranking machine learning model architecture in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

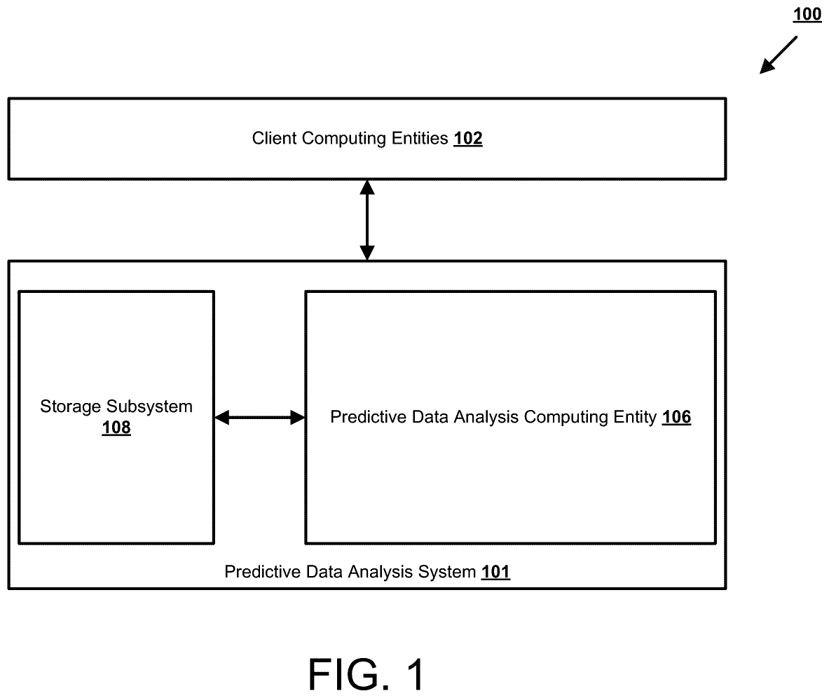

FIG. 1 provides an example overview of an architecture 100 in accordance with some embodiments of the present disclosure. The architecture 100 includes a predictive data analysis system 101 configured to receive predictive data analysis requests and/or suggestion requests from client computing entities 102, process the predictive data analysis requests and/or suggestion requests to generate predictions and/or content item rankings, and provide the generated predictions, the content item rankings, and/or a selection of content items based on the content item rankings to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, a predictive machine learning model is trained to generate predictions for content items based on a plurality of content item feature vectors and one or more personalized feature vectors. The plurality of content item feature vectors may be representative of content item feature vectors in a list of suggestions and the one or more personalized feature vectors may be representative of activity data reflecting user search behavior, user click information, and/or transactions with entities. Predictions for the content items may be used to assign rankings to the content items in one or more lists of suggestions associated with respective one or more search queries or word prefixes such that the content items may be selected from the one or more lists of suggestions and provided as suggestions in response to search input. This technique will improve embeddings for incorporating personalized relevancy by merging features of content items and user activities, leading to higher accuracy of performing predictive operations as needed on generating suggestions, such as typeahead suggestions or search results. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests and/or suggestion requests from client computing entities 102, process the predictive data analysis requests and/or suggestion requests to generate predictions and/or content item rankings, and provide the generated predictions, the content item rankings, and/or a selection of content items based on the content item rankings to the client computing entities 102.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### A. Example Predictive Data Analysis Computing Entity

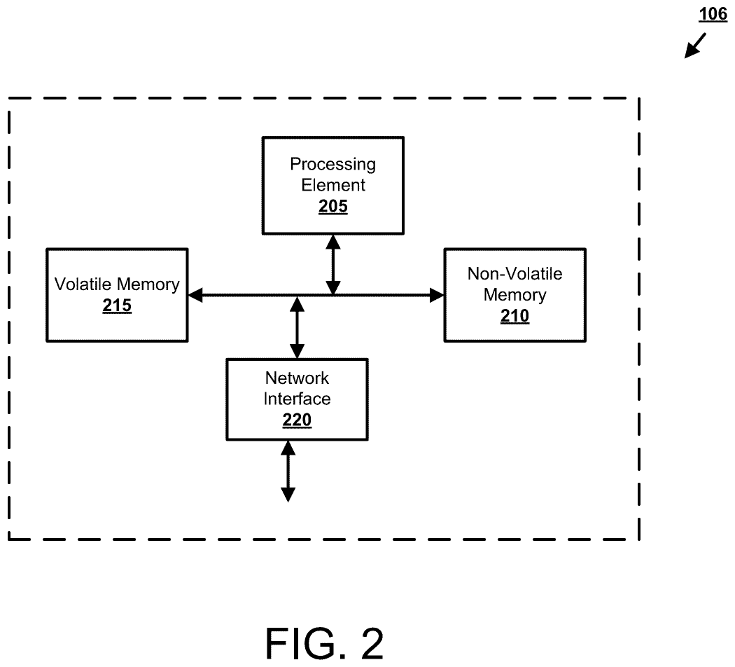

FIG. 2 provides an example predictive data analysis computing entity 106 in accordance with some embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes may be performed on data, content, information, and/or similar terms used herein interchangeably.

As shown in FIG. 2, in some embodiments, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the predictive data analysis computing entity 106 may further include, or be in communication with, non-volatile media (also referred to as non-volatile storage, memory, memory storage, memory circuitry, and/or similar terms used herein interchangeably). In some embodiments, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the predictive data analysis computing entity 106 may further include, or be in communication with, volatile media (also referred to as volatile storage, memory, memory storage, memory circuitry, and/or similar terms used herein interchangeably). In some embodiments, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in some embodiments, the predictive data analysis computing entity 106 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### B. Example Client Computing Entity

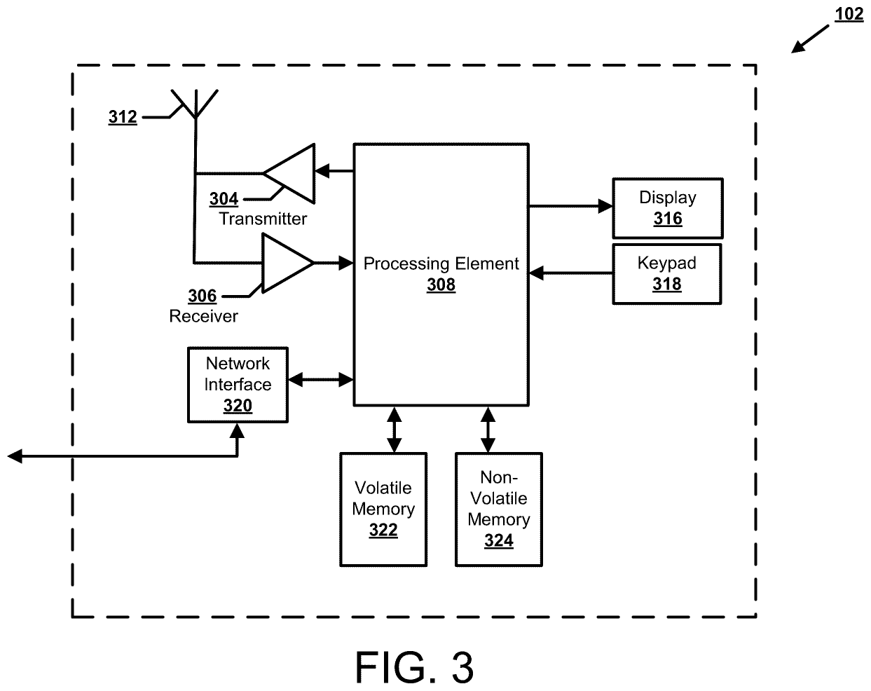

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface may comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the predictive data analysis computing entity 106 and/or various other computing entities.

In another embodiment, the client computing entity 102 may include one or more components or functionalities that are the same or similar to those of the predictive data analysis computing entity 106, as described in greater detail above. As will be recognized, these architectures and descriptions are provided for example purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “list of suggestions” refers to a data construct that describes a list of candidate content items that may be selected and used to generate one or more suggestions for a given search input. A list of suggestions may comprise a plurality of content items that are relevant to a specific search query, word prefix, or a specific sequence of characters. For example, a plurality of content items from a given list of suggestions may comprise one or more words, terms, or phrases associated with a specific search query, word prefix, or a specific sequence of characters. In some embodiments, an information retrieval system may comprise one or more lists of suggestions from which one or more content items may be retrieved from appropriate ones of the one or more lists of suggestions based on search input received (e.g., typed by a user into a text input field) matching the one or more lists of suggestions. In some embodiments, a list of suggestions is generated based on (i) a current or default list of content items, (ii) a list of content items generated based on overall frequency (e.g., most-frequently searched content items), (iii) age or gender category, (iv) user clickstream (e.g., most-frequently clicked or selected), or (iv) a combination thereof. That is, a list of suggestions may comprise a relatively expansive set of candidate content items from which a subset of the candidate content items may be selected to generate one or more suggestions based on an assignment of rankings to the candidate content items. In some embodiments, a list of suggestions comprises a plurality of content items that are associated with a respective plurality of initial rankings, where the plurality of content items is re-ranked by modifying the plurality of initial rankings based on a prediction for each of the plurality of content items generated by using a personalized re-ranking machine learning model.

In some embodiments, the term “entity” refers to a data construct that describes a data object, article, file, program, service, task, operation, computing entity, and/or the like that provides one or more resources (e.g., healthcare resources, etc.) for a user.

In some embodiments, the term “content item” refers to a data construct that describes a document or body of information associated with one or more entities. For example, a content item may comprise a webpage including information or functionality usable by a user visiting the webpage to facilitate transactions with an entity.

In some embodiments, the term “search input” refers to a data construct that describes a search query or word prefix provided by a user to, and received by, an information retrieval system. According to various embodiments of the present disclosure, search input may be entered by users into a graphical user interface (GUI) of an information retrieval system, and in response to the search input, one or more suggestions are generated comprising a plurality of content items. In some embodiments, search input may be received by a predictive data analysis system from one or more client computing entities, either directly or indirectly via, for example, an information retrieval system comprising a search engine.

In some embodiments, the term “search query” refers to a data construct that describes a request for information (e.g., content items). For example, a search query may comprise one or more words, terms, or a string of characters, numbers, symbols, or any combination thereof, that may be entered by a user and received by an information retrieval system (e.g., comprising a search engine). A search query may be used by an information retrieval system to match the search query with a list of suggestions comprising a corpus of content items for retrieval. According to various embodiments of the present disclosure, one or more suggestions are generated responsive to a search input comprising a search query received from a user (e.g., by an information retrieval system via a GUI) by selecting one or more of a plurality of content items from one of one or more lists of suggestions associated with the search query based on rankings assigned to the selected one or more content items.

In some embodiments, the term “word prefix” refers to a data construct that describes a string of characters, numbers, symbols, or any combination thereof, that may be identified as comprising one or more leading characters or a portion of one or more potential search queries. For example, a word prefix may comprise a partially entered search query. One or more content items may be retrieved from a list of suggestions based on a partially entered search query comprising a word prefix. According to various embodiments of the present disclosure, one or more suggestions are generated responsive to a search input comprising a word prefix received from a user (e.g., by an information retrieval system via a GUI) by selecting one or more of a plurality of content items from one of one or more lists of suggestions associated with the input word prefix based on rankings assigned to the selected one or more content items.

In some embodiments, the term “suggestion” refers to a data construct that describes a content item or reference to a content item that is provided (e.g., rendered on a GUI of an information retrieval system) in response to a search input received (e.g., by the information retrieval system) from a user. In some embodiments, a suggestion comprises a typeahead suggestion for either completion or replacement of a word prefix entered thus far by a user on a GUI of an information retrieval system. In some embodiments, a suggestion comprises a search result (e.g., on a search results page or preview of a search results page) in response to search input comprising a search query or a word prefix entered by the user on the GUI of the information retrieval system. For example, one or more suggestions may be rendered or presented to a user on a GUI of an information retrieval system while the user is typing (e.g., after a word prefix or a certain amount of characters, numbers, symbols, or any combination thereof, has been typed into a text input field) or after the user has finished typing (e.g., a whole search query). According to various embodiments of the present disclosure, one or more suggestions are generated based on rankings assigned to content items (e.g., from a list of suggestions) that are associated with a search input. According to various embodiments of the present disclosure, content items are suggested by an information retrieval system by (i) generating, using a personalized re-ranking machine learning model, a plurality of predictions for a plurality of content items from a list of suggestions based on a plurality of content item feature vectors and one or more personalized feature vectors, (ii) assigning a plurality of rankings to the plurality of content items based on the plurality of predictions, and (iii) generating one or more suggestions, responsive to a search input received from a user, by selecting one or more of the plurality of content items based on the plurality of rankings. In some embodiments, selecting the one or more of the plurality of content items comprises determining one or more content items comprising at least a minimum ranking from a list of suggestions. In some embodiments, selecting the one or more of the plurality of content items comprises selecting top ranking ones of the plurality of content items (e.g., comprising the highest rankings) from the list of suggestions. For example, a plurality of content items from a list of suggestions may be more than a target number of content items to display to a user, and as such, a subset of the plurality of content items may be selected for generating one or more suggestions.

In some embodiments, the term “typeahead suggestion” refers to a data construct that describes a content item or reference to a content item that is retrieved and/or provided as a suggestion for completion of a word prefix entered by a user on a GUI of an information retrieval system. For example, one or more typeahead suggestions may be generated based on rankings assigned to content items associated with a word prefix that a user has provided thus far via a GUI of an information retrieval system. One or more typeahead suggestions may be rendered or presented to a user on a GUI of an information retrieval system while the user is typing (e.g., after a word prefix or a certain amount of characters, numbers, symbols, or any combination thereof, has been typed into a text input field). In some embodiments, typeahead suggestions that have been generated and/or presented may be dynamically changed or be updated as the user is typing (e.g., to match typeahead suggestions to changing search input). Typeahead suggestions may be reviewed and accepted to complete or replace search input received from a user by an information retrieval system (e.g., via a GUI). In some embodiments, rankings are assigned to content items in one or more lists of suggestions based on predictions for the content items such that content items may be selected from the one or more lists of suggestions to generate one or more typeahead suggestions in response to receiving word prefixes associated with the one or more lists of suggestions.

In some embodiments, the term “search result” refers to a data construct that describes a content item or reference to a content item that is retrieved and/or provided by an information retrieval system based on a search input. For example, a search results page (or preview of a search results page) comprising one or more search results may be generated in response to a search input comprising a search query or a word prefix received by the information retrieval system from a user (e.g., entered via a GUI of the information retrieval system). According to various embodiments of the present disclosure, one or more suggestions comprising one or more search results are generated based on rankings assigned to content items (e.g., from a list of suggestions) that are associated with a search input.

In some embodiments, the term “ranking” refers to a data construct that describes a rank, position, or order assigned to a member of a set of data elements, such as content items in a list of suggestions, based on an evaluation or grading of the member relative to one or more other members within the set. In some embodiments, a ranking may be representative of relevancy or likelihood of a given user selecting a given content item assigned the ranking (relative to other content items within a list of suggestions) and/or transacting with entities associated with the given content item assigned the ranking. According to various embodiments of the present disclosure, a plurality of rankings are assigned to a plurality of content items based on a plurality of predictions for the plurality of content items. For example, a ranking may be assigned to a content item in a list of suggestions based on a prediction for the content item by using a personalized re-ranking machine learning model.

In some embodiments, the term “initial ranking” refers to a data construct that describes a default or first ranking assigned to a member of a set, such as a content item in a list of suggestions. For example, an initial ranking may be assigned to a content item in a list of suggestions prior to generating a prediction for the content item and assigning a ranking to the content item based on the prediction. In some embodiments, an initial ranking may be assigned to each of a plurality of content items in a list of suggestions based on a weighted combination of one or more of overall search frequency, age, gender category, or user clickstream.

In some embodiments, the term “prediction” refers to a data construct that describes an output generated by an output layer of a machine learning model. According to various embodiments of the present disclosure, a plurality of predictions for a plurality of content items are generated using a personalized re-ranking machine learning model based on a plurality of content item feature vectors, one or more personalized feature vectors, and a plurality of position embeddings. In some embodiments, a plurality of predictions for a plurality of content items comprises a respective plurality of probabilities of a user selecting the plurality of content items and/or transacting with entities associated with the plurality of content items. That is, the plurality of predictions may represent a determination of relevancy of the plurality of content items to a user's interest or search query intent. In some embodiments, a plurality of rankings is assigned to a plurality of content items based on a plurality of predictions for the plurality of content items.

In some embodiments, the term “content item feature vector” refers to a data construct that describes a latent representation of one or more features associated with a content item. For example, a content item feature vector may comprise a numerical representation (or an embedding) of features associated with a content item. A content item feature vector may comprise one or more embeddings associated with activity data with respect to a content item, such as whether a content item was provided, clicked, or transacted with when specific search input is provided. In some embodiments, a content item feature vector comprises embeddings associated with one or more features of a content item, such as text, search frequency, click/selection frequency, impression, transaction frequency and types, taxonomy category, or custom/business rule-related features. In some embodiments, search results from search session data may be used to mimic typeahead suggestions for modeling relevance of synthetic typeahead suggestions to user search inputs. In some embodiments, the one or more features of a content item is associated with interactions with certain user demographics (e.g., by age group or gender) or characteristics specific to certain demographics (e.g., migraines and depression rates). In some embodiments, the one or more features of a content item comprise characteristics of an entity associated with the content item. In some embodiments, the characteristics of an entity is derived from its transaction data (e.g., accepting certain transactions). For example, an information retrieval system may determine one or more entities are accepting new clients, patrons, or patients based on transaction data of the one or more entities confirming such. In some embodiments, the one or more features of a content item comprise entity metrics, such as cost, quality/rating, and availability. In some embodiments, custom/business rule-related features comprise restriction or filtering criteria, such as average cost, rating, quality, distance, or tiering, based on importance, preference, or priority of particular searches. For example, distance and cost may be important for a primary care physician search, but clinical quality may be important for an oncologist search. According to various embodiments of the present disclosure, a plurality of content item feature vectors associated with a plurality of content items from a list of suggestions (e.g., a content item feature vector for each content item in the list of suggestions) is generated and used to generate a plurality of predictions for the plurality of content items. In some embodiments, content item feature vectors are generated from content item feature vectors data (e.g., features of content items) using a personalized re-ranking machine learning model. For example, a content item feature vector may be generated at an input layer of a personalized re-ranking machine learning model. In some embodiments, one or more content item feature vectors are generated and used to train (e.g., update one or more parameters) a personalized re-ranking machine learning model based on training data comprising label assignments associated with search query-content item record pairs.

In some embodiments, the term “activity data” refers to a data construct that describes at least one of search session data or transaction data. In some embodiments, one or more personalized feature vectors are generated based on activity data associated with a user. In some embodiments, training data is generated based on activity data associated with a user for training a personalized re-ranking machine learning model to generate a plurality of predictions for a plurality of content items (from a list of suggestions). In some embodiments, a content item feature vector comprises one or more embeddings associated with activity data with respect to a content item, such as whether a content item was provided, clicked, or transacted with when specific search input is provided.

In some embodiments, the term “search session data” refers to a data construct that describes information about a user's activities and interactions with an information retrieval system, such as a website comprising a search engine. For example, search session data may comprise clickstream events data from search logs (e.g., comprising search queries and search results), website activity logs, or user search click feedback, such as user interactions with content items or search results (e.g., content items or search results selected or navigated by a user), and content item and prefix interactions (e.g., content items selected by a specific user when typing word prefixes). According to various embodiments of the present disclosure, one or more personalized feature vectors is generated based on search session data associated with a user.

In some embodiments, the term “transaction data” refers to a data construct that describes a bill of sale, receipt, or confirmation associated with an activity between an entity and a user. The activity may comprise a transaction or interaction and one or more categorical identifiers, taxonomies, or descriptions describing goods or services provided by an entity to a user at a specific date/time and location. In some embodiments, transaction data comprises claims data including information such as, diagnoses, procedures, or treatments performed by a healthcare provider (entity) on a user (e.g., in the form of ICD and/or CPT codes, or National Uniform Claim Committee taxonomies). In some embodiments, characteristics of entities associated with content items may be determined from transaction data associated with the respective entities and used to generate content item feature vectors.

In some embodiments, the term “personalized feature vector” refers to a data construct that describes a latent representation of one or more features associated with a user. For example, a personalized feature vector may comprise a numerical representation (or an embedding) of features associated with a user comprising one or more of search session data (e.g., content item and word prefix interactions (clicks), word prefix and user interaction (clicks), or word prefix embeddings), transaction data, or user information, such as age, or gender category. In some embodiments, a personalized feature vector may comprise a numerical representation of custom/business rule related features, such as an excluded subset of content items to specific groups of users. According to various embodiments of the present disclosure, one or more personalized feature vectors associated with a user is generated based on activity data associated with the user, where the one or more personalized feature vectors are used to generate a plurality of predictions for a plurality of content items. In some embodiments, one or more personalized feature vectors are generated from personalized features data using a personalized re-ranking machine learning model. For example, one or more personalized feature vectors may be generated at an input layer of a personalized re-ranking machine learning model. In some embodiments, one or more personalized feature vectors are generated and used to train (e.g., update one or more parameters) a personalized re-ranking machine learning model based on activity data associated with a user.

In some embodiments, the term “embedding” refers to a data construct that describes a latent representation of data comprising one or more features. For example, an embedding of data may be expressed as a vector comprising one or more numbers representative of one or more features associated with content of data. In some embodiments, an embedding may be generated by mapping one or more features to one or more elements in a vector space.

In some embodiments, the term “position embedding” refers to a data construct that describes a latent representation of sequential or position order information associated with a plurality of rankings assigned to a plurality of content items within a list of suggestions. A position embedding associated with a list of suggestions may be used to train a personalized re-ranking machine learning model in combination with, for example, a plurality of content item feature vectors associated with a plurality of content items from the list of suggestions and one or more personalized feature vectors associated with a user to generate a plurality of predictions for the plurality of content items. In some embodiments, position embedding may be used to account for position bias of a plurality of content items in a list of suggestions. For example, content items that are presented in topmost or most prominent positions have higher likelihoods of being selected by a user regardless of relevancy. In some embodiments, one or more position embeddings are generated from content item position data using a personalized re-ranking machine learning model. For example, one or more position embeddings may be generated at an input layer of a personalized re-ranking machine learning model. In some embodiments, one or more position embeddings are generated and used to train (e.g., update one or more parameters) a personalized re-ranking machine learning model based on position or order information of one or more training content items associated with a list of suggestions. In some embodiments, generating a position embedding for a training content item comprises (i) determining an examination probability of a given position and a relevance probability of the training content item being relevant for a search input based on regression-based expectation-maximization of search session data and (ii) generating a position bias correction for an initial ranking of the training content item based on a position bias model, the examination probability, and the relevance probability.

In some embodiments, the term “training data” refers to data used to train a machine learning model to perform a desired prediction task. A machine learning model (and its weights and/or parameters) may be configured to learn (or trained on) features associated with the training data. For example, training data may comprise data including example associations between one or more training content items (e.g., of a search query-content item record pair) and respective one or more labels, wherein the one or more labels comprise actual classifications of the one or more training content items (or search query-content item record pair). In some embodiments, training data is extracted from and/or generated based on activity data associated with a user. In some embodiments, training data comprises or is generated based on one or more of search inputs, search results (e.g., list of content items) associated with respective ones of the search inputs, clicked content items, and/or content items transacted with. The training data may be used to train a personalized re-ranking machine learning model. In some embodiments, activity data used to generate training data comprises search session data and/or transaction data of a user during a given time window (e.g., days, weeks, or months, etc.). As such, a user's intent during the given time window may be captured from activity data and used, for example, to train a personalized re-ranking machine learning model to generate predictions for suggestion content items.

In some embodiments, training data is generated by labeling one or more search query-content item record pairs. In some embodiments, generating training data comprises (i) generating a plurality of label sets comprising (a) a first label set representative of a selection of a training content item by a user based on search session data associated with the user and (b) a second label set representative of one or more transactions conducted by the user with an entity associated with the training content item based on transaction data associated with the user, (ii) determining, by the one or more processors, a dominant label set from the plurality of label sets based on an occurrence frequency associated with the first label set and the second label set, (iii) responsive to an occurrence of an event associated with the dominant label set, assigning, by the one or more processors, a first label associated with the dominant label set to one or more first search query-content item record pairs associated with a training dataset, (iv) responsive to a non-occurrence of the event associated with the dominant label set, assigning, by the one or more processors, one or more stochastic labels from the plurality of label sets comprising a second label associated with the dominant label set, or one or more third labels associated with a non-dominant label set, to one or more second search query-content item record pairs associated with the training dataset. In some embodiments, one or more parameters associated with a machine learning model are updated based on training data comprising the label assignments associated with the one or more first search query-content item record pairs and the second search query-content item record pairs. The machine learning model may generate a plurality of predictions (e.g., on a plurality of suggestion content items associated with a list of suggestions) based on the one or more parameters.

In some embodiments, the term “label set” refers to a data construct that describes a collection of one or more labels that characterizes a specific feature associated with training data (e.g., comprising one or more search query-content item record pairs). That is, a label set may be associated with an aspect of a desired prediction target for training a machine learning model. In some embodiments, a label set comprises one or more labels associated with a classification (e.g., binary or multi-class, of training data with respect to a feature).

In some embodiments, the term “label” refers to a data construct that describes descriptions, tags, or identifiers that classify or emphasize features associated with training data (e.g., comprising one or more search query-content item record pairs). A label may be used to guide training of a machine learning model towards a prediction target. In an example embodiment, a label may comprise an example classification of a training content item (or a search query-content item record pair) for training a machine learning model to generate predictions for suggestion content items. In some embodiments, each of one or more search query-content item record pairs is assigned a label to generate training data for training (e.g., updating one or more parameters) a machine learning model. In some embodiments, a label may be associated with (i) a selection of a training content item by a user or (ii) one or more transactions conducted by the user with an entity associated with the training content item.

In some embodiments, the term “dominant label set” refers to a data construct that describes a set of labels associated with an occurrence of an event that is used to determine which one of a plurality of label sets are used to label a training dataset. For example, a search query-content item record pair may be assigned a label associated with a dominant label set selected from a plurality of label sets based on an occurrence of an event associated with the dominant label set, otherwise, the search query-content item record pair may be assigned with one or more stochastic labels from the plurality of label sets comprising a second label associated with the dominant label set, or one or more third labels associated with a non-dominant label set, based on a non-occurrence of the event associated with the dominant label set. According to various embodiments of the present disclosure, one of a plurality of label sets is determined as a dominant label set based on occurrence frequency. In some embodiments, a dominant label set comprises one of a plurality of label sets comprising a lowest occurrence frequency.

In some embodiments, the term “search query-content item record pair” refers to a data construct that describes at least a portion of a training dataset comprising a search query and a content item record associated with the search query. According to various embodiments of the present disclosure, a machine learning model, such as a personalized re-ranking machine learning model, is trained on a training dataset comprising one or more search query-content item record pairs.

In some embodiments, the term “content item record” refers to a data construct that describes activity data associated with a user with respect to a training content item. For example, a content item record may comprise information extracted from search session data, such as search query/prefix, search results, or click/selection data, and/or transaction data comprising transactions of a user with one or more entities associated with a training content item within a given time window, such as 45 days.

In some embodiments, the term “personalized re-ranking machine learning model” refers to a data construct that describes parameters, hyperparameters, and/or defined operations of a machine learning model that is configured to (i) receive one or more lists of suggestions that comprise a plurality of content items associated with a plurality of entities, (ii) generate a plurality of content item feature vectors associated with the plurality of content items, (iii) generate one or more personalized feature vectors based on activity data associated with a user, and (iv) generate a plurality of predictions for the plurality of content items based on the plurality of content item feature vectors and the one or more personalized feature vectors. In some embodiments, the personalized re-ranking machine learning model comprises a transformer machine learning model.

### IV. OVERVIEW

Various embodiments of the present disclosure make important technical contributions to predictive analysis that address the efficiency and reliability shortcomings of existing predictive analysis solutions. For example, some techniques of the present disclosure improve the predictive accuracy of predictive machine learning models used in generating suggestions for search queries. To do so, the predictive machine learning models may be trained to generate predictions for a plurality of content items in lists of suggestions based on a plurality of content item feature vectors associated with the plurality of content items and one or more personalized feature vectors of a specific user. By doing so, some of the techniques of the present disclosure improve training data quality and training efficiency of training predictive machine learning models while improving the predictive performance of the resulting models. It is well-understood in the relevant art that there is typically a bottleneck of predictive accuracy due to training data quality. Technical challenges related to the preparation of training data result in less accurate machine learning models due to low training data quality.

Some embodiments of the present disclose improved traditional training techniques by addressing these technical challenges. Specifically, some of the training techniques of the present disclosure enable the preparation of training data with application relevant and reliable features. For example, training data may comprise (i) a plurality of content item feature vectors associated with a plurality of content items and/or (ii) one or more personalized feature vectors associated with activity data of a user. The training data may be leveraged by improved machine learning model architectures to provide practical improvements with respect to various predictive techniques, including the resolution of search queries. In this manner, some of the techniques of the present disclosure improve predictive accuracy without harming training speed by improving training data quality. In doing so, some of the techniques described herein improve the efficiency and resulting quality of training data for predictive machine learning models, thus reducing the number of computational operations needed and/or the amount of training data entries needed to train predictive machine learning models.

Various embodiments of the present disclosure improve predictive accuracy of predictive machine learning models by generating predictions for a plurality of content items based on a combination of content item feature vectors and personalized feature vectors of a specific user. As described herein, identifying user query intention (e.g., as encoded by the personalized feature vectors, etc.) and assisting users in finding more relevant content items (e.g., to facilitate transactions with entities providing goods or services desired by the users) may improve information retrieval quality. For example, by ranking content items based on predictions of the content items being more relevant to a user's intent (e.g., as reflected by prior activities, etc.), improved search results may be retrieved by search engines (e.g., information retrieval systems). Search session data comprising clickstream events data from search logs may provide valuable information about how users interact with search engines (e.g., information retrieval systems, etc.) and relevance of any previous suggestions, such as typeahead suggestions, or search results. In particular, search session data may reflect user search behavior and user click information. As such, search session data may provide feedback to guide a content item ranking process, which may improve content item selection for future suggestions or search results retrieval.

In accordance with various embodiments of the present disclosure, a predictive machine learning model may be trained to generate predictions for content items based on a plurality of content item feature vectors and one or more personalized feature vectors. The plurality of content item feature vectors may be representative of content item feature vectors in one or more lists of suggestions, whereas the one or more personalized feature vectors may be representative of activity data reflecting user search behavior, user click information, and/or transactions with entities. Using the new combination of feature vectors, improved predictions may be generated for one or more content items, in response to search input, based on encoded content item information (e.g., content item feature vectors, etc.), while being tailored to encoded user information (e.g., personalized feature vector, etc.). In this manner, some of the techniques of the present disclosure, improve traditional search embeddings by incorporating measures of personalized relevancy by merging features of content items and user search activities. This enables higher accuracy for performing predictive operations with respect to individual users, which, in turn, enables improved predictive performance of machine learning models that are capable of discovering and then tailoring their predictions to individual user intents.

In accordance with various embodiments of the present disclosure, predictions may be generated for a plurality of content items in one or more lists of suggestions to rank the content items with respect to specific search input comprising a search query or a word prefix. By doing so, content items may be intelligently selected, in real time, from the one or more lists of suggestions and provided as typeahead suggestions, search results, and/or the like. In this way, some of the techniques of the present disclosure may be practically applied, in real time, to improve search and content item recommendations, relative to traditional search engines.

Examples of technologically advantageous embodiments of the present disclosure include: (i) prediction machine learning techniques that leverage unique sets of embeddings to generate improved predictions, (ii) real-time ranking and recommendation techniques for generating improved content item suggestions, (iii) machine learning training techniques for improving model accuracy while reducing computational resource usage, among others. Other technical improvements and advantages may be realized by one of ordinary skill in the art.

### V. EXAMPLE SYSTEM OPERATIONS

As indicated, various embodiments of the present disclosure make important technical contributions to predictive analysis that address the efficiency and reliability shortcomings of existing predictive analysis solutions. By doing so, content items may be intelligently selected, in real time, from one or more lists of suggestions and provided as typeahead suggestions, search results, and/or the like. In this way, some of the techniques of the present disclosure may be practically applied, in real time, to improve search and content item recommendations, relative to traditional search engines.

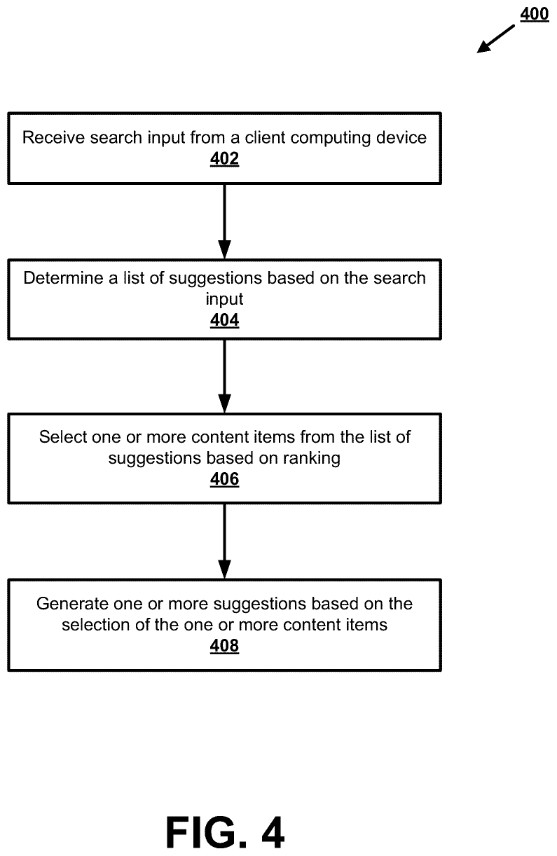

FIG. 4 is a flowchart diagram of an example process 400 for generating suggestions for search input in accordance with some embodiments of the present disclosure.

In some embodiments, via the various steps/operations of the process 400, the predictive data analysis computing entity 106 generates a plurality of predictions for a plurality of content items from one or more lists of suggestions associated with a respective plurality of search queries or word prefixes, assign a plurality of rankings to the plurality of content items based on the plurality of predictions, and generate one or more suggestions, responsive to a search input received from a user matching one of the one or more lists of suggestions, by selecting one or more of the plurality of content items from the matching one of the one or more lists of suggestions based on the plurality of rankings.

In some embodiments, the process 400 begins at step/operation 402 when the predictive data analysis computing entity 106 receives a search input from a client computing device. A search input may comprise a search query or word prefix provided by a user to, and received by, an information retrieval system. According to various embodiments of the present disclosure, search input may be entered by users into a graphical user interface (GUI) of an information retrieval system. In some embodiments, search input may be received by a predictive data analysis system from one or more client computing entities, either directly or indirectly via (e.g., an information retrieval system comprising a search engine).

In some embodiments, a search query describes a request for information (e.g., content items). For example, a search query may comprise one or more words, terms, or a string of characters, numbers, symbols, or any combination thereof, that may be entered by a user and received by an information retrieval system (e.g., comprising a search engine).

In some embodiments, a word prefix describes a string of characters, numbers, symbols, or any combination thereof, that may be identified as comprising one or more leading characters or a portion of one or more potential search queries. For example, a word prefix may comprise a partially entered search query.

According to various embodiments of the present disclosure, the search input may be received by predictive data analysis system 101 and/or predictive data analysis computing entity 106 from one or more client computing entities 102, either directly or indirectly via, for example, an information retrieval system comprising a search engine. In some embodiments, the search input may be typed into a text input field and monitored by the predictive data analysis computing entity 106.

In some embodiments, at step/operation 404, the predictive data analysis computing entity 106 determines a list of suggestions based on the search input. In some embodiments, a list of suggestions describes a list of candidate content items that may be selected and used to generate one or more suggestions for a given search input. A list of suggestions may comprise a plurality of content items that are relevant to a specific search query, word prefix, or a specific sequence of characters. For example, a plurality of content items from a given list of suggestions may comprise one or more words, terms, or phrases associated with a specific search query, word prefix, or a specific sequence of characters. In some embodiments, an information retrieval system may comprise one or more lists of suggestions from which one or more content items may be retrieved from appropriate ones of the one or more lists of suggestions based on search input received (e.g., typed by a user into a text input field) matching the one or more lists of suggestions.

In some embodiments, a list of suggestions is generated based on (i) a current or default list of content items, (ii) a list of content items generated based on overall frequency (e.g., most-frequently searched content items), (iii) age or gender category, (iv) user clickstream (e.g., most-frequently clicked or selected), or (iv) a combination thereof. That is, a list of suggestions may comprise a relatively expansive set of candidate content items from which a subset of the candidate content items may be selected to generate one or more suggestions based on an assignment of rankings to the candidate content items.

In some embodiments, a content item describes a document or body of information associated with one or more entities. For example, a content item may comprise a webpage including information or functionality usable by a user visiting the webpage to facilitate transactions with an entity. In some embodiments, an entity describes a data object, article, file, program, service, task, operation, computing entity, and/or the like unit comprising a source of resources.

In some embodiments, at step/operation 406, the predictive data analysis computing entity 106 selects one or more content items from the list of suggestions based on ranking. In some embodiments, a ranking describes a rank, position, or order assigned to a member of a set of data elements, such as content items in a list of suggestions, based on an evaluation or grading of the member relative to one or more other members within the set. In some embodiments, a ranking may be representative of relevancy or likelihood of a given user selecting a given content item assigned the ranking (relative to other content items within a list of suggestions) and/or transacting with entities associated with the given content item. In some embodiments, selecting the one or more of the plurality of content items comprises determining one or more content items comprising at least a minimum ranking from a list of suggestions. In some embodiments, selecting the one or more of the plurality of content items comprises selecting top ranking ones of the plurality of content items (e.g., comprising the highest rankings) from the list of suggestions. For example, a plurality of content items from a list of suggestions may be more than a target number of content items to display to a user, and as such, a subset of the plurality of content items may be selected.

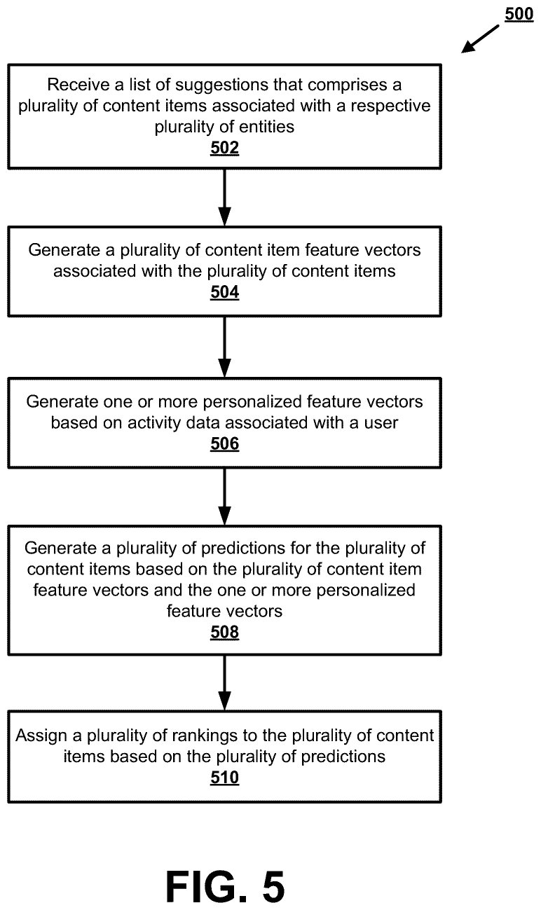

According to various embodiments of the present disclosure, a plurality of rankings are assigned to a plurality of content items based on a plurality of predictions for the plurality of content items. For example, a ranking may be assigned to a content item in a list of suggestions based on a prediction for the content item by using a personalized re-ranking machine learning model. Assigning rankings to content items is described in further detail with respect to the description of FIG. 5.

In some embodiments, a list of suggestions comprises a plurality of content items that are associated with a respective plurality of initial rankings, where the plurality of content items is re-ranked by modifying the plurality of initial rankings based on a prediction for each of the plurality of content items generated by using a personalized re-ranking machine learning model. In some embodiments, an initial ranking describes a default or first ranking assigned to a member of a set, such as a content item in a list of suggestions. For example, an initial ranking may be assigned to a content item in a list of suggestions prior to generating a prediction for the content item and assigning a ranking to the content item based on the prediction. In some embodiments, an initial ranking may be assigned to each of a plurality of content items in a list of suggestions based on a weighted combination of one or more of overall search frequency, age, gender category, or user clickstream.

In some embodiments, rankings are assigned to content items in one or more lists of suggestions based on predictions for the content items such that the content items may be selected from the one or more lists of suggestions to generate one or more suggestions in response to receiving search input.

In some embodiments, at step/operation 408, the predictive data analysis computing entity 106 generates one or more suggestions based on the selection of the one or more content items. That is, one or more suggestions comprising the one or more content items selected from the list of suggestions are generated in response to the search input. In some embodiments, a suggestion describes a content item or reference to a content item that is provided (e.g., rendered on a GUI of an information retrieval system) in response to a search input received (e.g., by the information retrieval system) from a user. In some embodiments, a suggestion comprises a typeahead suggestion for either completion or replacement of a word prefix entered thus far by a user on a GUI of an information retrieval system. In some embodiments, a suggestion comprises a search result (e.g., on a search results page or preview of a search results page) in response to search input comprising a search query or a word prefix entered by the user on the GUI of the information retrieval system. For example, one or more suggestions may be rendered or presented to a user on a GUI of an information retrieval system while the user is typing (e.g., after a word prefix or a certain amount of characters, numbers, symbols, or any combination thereof, has been typed into a text input field) or after the user has finished typing (e.g., a whole search query).

In some embodiments, a typeahead suggestion describes a content item or reference to a content item that is retrieved and/or provided as a suggestion for completion of a word prefix entered by a user on a GUI of an information retrieval system. For example, one or more typeahead suggestions may be generated based on rankings assigned to content items associated with a word prefix that a user has provided thus far via a GUI of an information retrieval system. One or more typeahead suggestions may be rendered or presented to a user on a GUI of an information retrieval system while the user is typing (e.g., after a word prefix or a certain amount of characters, numbers, symbols, or any combination thereof, has been typed into a text input field). In some embodiments, typeahead suggestions that have been generated and/or presented may be dynamically changed or be updated as the user is typing (e.g., to match typeahead suggestions to changing search input). Typeahead suggestions may be reviewed and accepted to complete or replace search input received from a user by an information retrieval system (e.g., via a GUI). In some embodiments, rankings are assigned to content items in one or more lists of suggestions based on predictions for the content items such that content items may be selected from the one or more lists of suggestions to generate one or more typeahead suggestions in response to receiving word prefixes associated with the one or more lists of suggestions.

In some embodiments, a search result describes a content item or reference to a content item that is retrieved and/or provided by an information retrieval system based on a search input. For example, a search results page (or preview of a search results page) comprising one or more search results may be generated in response to a search input comprising a search query or a word prefix received by the information retrieval system from a user (e.g., entered via a GUI of the information retrieval system). According to various embodiments of the present disclosure, one or more suggestions comprising one or more search results are generated based on rankings assigned to content items (e.g., from a list of suggestions) that are associated with a search input.

FIG. 5 is a flowchart diagram of an example process 500 for assigning rankings to content items in accordance with some embodiments of the present disclosure.

In some embodiments, via the various steps/operations of the process 500, the predictive data analysis computing entity 106 uses a personalized re-ranking machine learning model to generate a plurality of predictions for a plurality of content items from respective one or more lists of suggestions.

In some embodiments, a personalized re-ranking machine learning model describes parameters, hyperparameters, and/or defined operations of a machine learning model that is configured to (i) receive one or more lists of suggestions that comprise a plurality of content items associated with a plurality of entities, (ii) generate a plurality of content item feature vectors associated with the plurality of content items, (iii) generate one or more personalized feature vectors based on activity data associated with a user, and (iv) generate a plurality of predictions for the plurality of content items based on the plurality of content item feature vectors and the one or more personalized feature vectors. In some embodiments, the personalized re-ranking machine learning model comprises a transformer machine learning model.

In some embodiments, the process 500 begins at step/operation 502 when the predictive data analysis computing entity 106 receives, using a personalized re-ranking machine learning model, a list of suggestions that comprises a plurality of content items associated with a plurality of entities.

In some embodiments, at step/operation 504, the predictive data analysis computing entity 106 generates, using the personalized re-ranking machine learning model, a plurality of content item feature vectors associated with the plurality of content items. In some embodiments, a content item feature vector describes a latent representation of one or more features associated with a content item. For example, a content item feature vector may comprise a numerical representation (or an embedding) of features associated with a content item.

In some embodiments, an embedding describes a latent representation of data comprising one or more features. For example, an embedding of data may be expressed as a vector comprising one or more numbers representative of one or more features associated with content of data. In some embodiments, an embedding may be generated by mapping one or more features to one or more elements in a vector space. A content item feature vector may comprise one or more embeddings associated with activity data with respect to a content item, such as whether a content item was provided, clicked, or transacted with when specific search input is provided. In some embodiments, a content item feature vector comprises embeddings associated with one or more features of a content item, such as text, search frequency, click/selection frequency, impression, transaction frequency and types, taxonomy category, or custom/business rule-related features. In some embodiments, search results from search session data may be used to mimic typeahead suggestions for modeling relevance of synthetic typeahead suggestions to user search inputs.

In some embodiments, the one or more features of a content item is associated with interactions with certain user demographics (e.g., by age group or gender) or characteristics specific to certain demographics (e.g., migraines and depression rates). In some embodiments, the one or more features of a content item comprise characteristics of an entity associated with the content item. In some embodiments, the characteristics of an entity is derived from entity transaction data (e.g., accepting certain transactions). For example, an information retrieval system may determine one or more entities are accepting new clients, patrons, or patients based on transaction data of the one or more entities confirming such. In some embodiments, the one or more features of a content item comprise entity metrics, such as cost, quality/rating, and availability. In some embodiments, custom/business rule-related features comprise restriction or filtering criteria, such as average cost, rating, quality, distance, or tiering, based on importance, preference, or priority of particular searches. For example, distance and cost may be important for a primary care physician search, but clinical quality may be important for an oncologist search.

According to various embodiments of the present disclosure, a plurality of content item feature vectors associated with a plurality of content items from a list of suggestions (e.g., a content item feature vector for each content item in the list of suggestions) is generated and used to generate a plurality of predictions for the plurality of content items. In some embodiments, content item feature vectors are generated from content item feature vectors data (e.g., features of content items) using a personalized re-ranking machine learning model. For example, a content item feature vector may be generated at an input layer of a personalized re-ranking machine learning model.

In some embodiments, at step/operation 506, the predictive data analysis computing entity 106 generates, using the personalized re-ranking machine learning model, one or more personalized feature vectors based on activity data associated with a user.

In some embodiments, a personalized feature vector describes a latent representation of one or more features associated with a user. For example, a personalized feature vector may comprise a numerical representation (or an embedding) of features associated with a user comprising one or more of search session data (e.g., content item and word prefix interactions (clicks), word prefix and user interaction (clicks), or word prefix embeddings), transaction data, or user information, such as age, or gender category. In some embodiments, a personalized feature vector may comprise a numerical representation of custom/business rule related features, such as an excluded subset of content items to specific groups of users. In some embodiments, one or more personalized feature vectors are generated at an input layer of a personalized re-ranking machine learning model.

In some embodiments, activity data describes at least one of search session data or transaction data. In some embodiments, one or more personalized feature vectors are generated based on activity data associated with a user. In some embodiments, training data is generated based on activity data associated with a user for training a personalized re-ranking machine learning model to generate a plurality of predictions for a plurality of content items (from a list of suggestions). In some embodiments, a content item feature vector comprises one or more embeddings associated with activity data with respect to a content item, such as whether a content item was provided, clicked, or transacted with when specific search input is provided.

In some embodiments, search session data describes information about a user's activities and interactions with an information retrieval system, such as a website comprising a search engine. For example, search session data may comprise clickstream events data from search logs (e.g., comprising search queries and search results), website activity logs, or user search click feedback, such as user interactions with content items or search results (e.g., content items or search results selected or navigated by a user), and content item and prefix interactions (e.g., content items selected by a specific user when typing word prefixes). According to various embodiments of the present disclosure, one or more personalized feature vectors is generated based on search session data associated with a user.

In some embodiments, transaction data describes a bill of sale, receipt, or confirmation associated with an activity between an entity and a user. The activity may comprise a transaction or interaction and one or more categorical identifiers, taxonomies, or descriptions describing goods or services provided by an entity to a user at a specific date/time and location. In some embodiments, transaction data comprises claims data including information such as, diagnoses, procedures, or treatments performed by a healthcare provider (entity) on a user (e.g., in the form of ICD and/or CPT codes, or National Uniform Claim Committee taxonomies). In some embodiments, characteristics of entities associated with content items may be determined from transaction data associated with the respective entities and used to generate content item feature vectors.

In some embodiments, at step/operation 508, the predictive data analysis computing entity 106 generates, using the personalized re-ranking machine learning model, a plurality of predictions for the plurality of content items based on the plurality of content item feature vectors and the one or more personalized feature vectors. In some embodiments, a prediction describes an output generated by an output layer of a machine learning model. In some embodiments, a plurality of predictions for a plurality of content items comprises a respective plurality of probabilities of a user selecting the plurality of content items and/or transacting with entities associated with the plurality of content items. That is, the plurality of predictions may represent a determination of relevancy of the plurality of content items to a user's interest or search query intent.

In some embodiments, the plurality of predictions is further generated based on a plurality of position embeddings associated with the list of suggestions. In some embodiments, a position embedding describes a latent representation of sequential or position order information associated with a plurality of rankings assigned to a plurality of content items within a list of suggestions. A position embedding associated with a list of suggestions may be used to train a personalized re-ranking machine learning model in combination with, for example, a plurality of content item feature vectors associated with a plurality of content items from the list of suggestions and one or more personalized feature vectors associated with a user to generate a plurality of predictions for the plurality of content items. In some embodiments, position embedding may be used to account for position bias of a plurality of content items in a list of suggestions. For example, content items that are presented in topmost or most prominent positions have higher likelihoods of being selected by a user regardless of relevancy. In some embodiments, one or more position embeddings are generated from content item position data using a personalized re-ranking machine learning model. For example, one or more position embeddings may be generated at an input layer of a personalized re-ranking machine learning model.

In some embodiments, at step/operation 510, the predictive data analysis computing entity 106 assigns a plurality of rankings to the plurality of content items based on the plurality of predictions. For example, content items associated with predictions comprising higher probabilities may be assigned higher rankings.

According to various embodiments of the present disclosure, training data is used to train the personalized re-ranking machine learning model. In some embodiments, training data describes data used to train a machine learning model to perform a desired prediction task. A machine learning model (and its weights and/or parameters) may be configured to learn (or trained on) features associated with the training data. For example, training data may comprise data including example associations between one or more training content items (e.g., of a search query-content item record pair) and respective one or more labels, wherein the one or more labels comprise actual classifications of the one or more training content items (or search query-content item record pair). In some embodiments, training data is extracted from and/or generated based on activity data associated with a user. In some embodiments, training data comprises or is generated based on one or more of search inputs, search results (e.g., list of content items) associated with respective ones of the search inputs, clicked content items, or content items transacted with, is used to train a personalized re-ranking machine learning model. In some embodiments, activity data used to generate training data comprises search session data and/or transaction data of a user during a given time window (e.g., days, weeks, or months). As such, a user's intent during the given time window may be captured from activity data and used, for example, to train a personalized re-ranking machine learning model to generate predictions for content items).

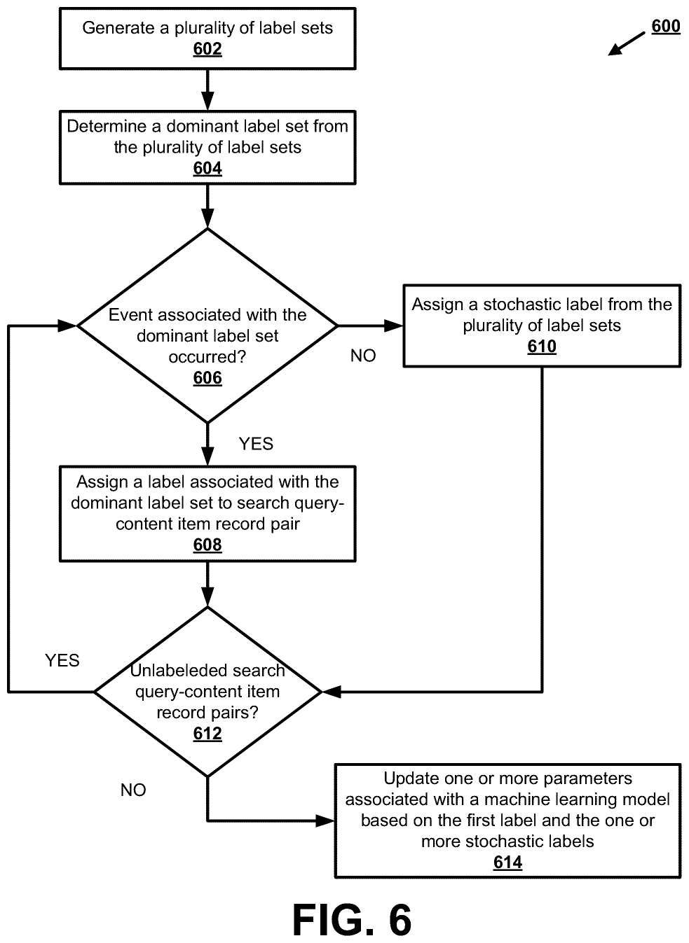

In some embodiments, one or more parameters associated with a machine learning model are updated based on training data. The machine learning model may generate a plurality of predictions (e.g., on a plurality of suggestion content items associated with a list of suggestions) based on the one or more parameters. In some embodiments, training data is generated by labeling one or more search query-content item record pairs, which is described in further detail with respect to the description of FIG. 6.

FIG. 6 is a flowchart diagram of an example process 600 for generating training data in accordance with some embodiments of the present disclosure.

In some embodiments, the process 600 begins at step/operation 602 when the predictive data analysis computing entity 106 generates a plurality of label sets. The plurality of label sets may comprise (i) a first label set representative of a selection of a content item by a user based on search session data associated with the user and (ii) a second label set representative of one or more transactions conducted by the user with an entity associated with the content item based on transaction data associated with the user. Each of the plurality of label sets may comprise one or more labels that are distinctive or unique to each label set.

In some embodiments, a label set describes a collection of one or more labels that characterizes a specific feature associated with training data (e.g., comprising one or more search query-content item record pairs). That is, a label set may be associated with an aspect of a desired prediction target for training a machine learning model. In some embodiments, a label set comprises one or more labels associated with a classification (e.g., binary or multi-class) of training data with respect to a feature.

In some embodiments, a label describes descriptions, tags, or identifiers that classify or emphasize features associated with training data (e.g., comprising one or more search query-content item record pairs). A label may be used to guide training of a machine learning model towards a prediction target. In an example embodiment, a label may comprise an example classification of a training content item (or a search query-content item record pair) for training a machine learning model to generate predictions for suggestion content items. In some embodiments, each of one or more search query-content item record pairs is assigned a label to generate training data for training (e.g., updating one or more parameters) a machine learning model. In some embodiments, a label may be associated with (i) a selection of a training content item by a user or (ii) one or more transactions conducted by the user with an entity associated with the training content item.

In some embodiments, at step/operation 604, the predictive data analysis computing entity 106 determines a dominant label set from the plurality of label sets. The dominant label set may be determined based on an occurrence frequency associated with the first label set and the second label set. In some embodiments, a dominant label set describes a set of labels associated with an occurrence of an event that is used to determine which one of a plurality of label sets are used to label a training dataset. In some embodiments, a dominant label set comprises one of a plurality of label sets comprising a lowest occurrence frequency. For example, a given one of a plurality of label sets may be determined as a dominant label set based on the given label set comprising a fewest number of event occurrences. That is, a label set associated with a most scarce event occurrence may be assigned as the dominant label set. In some embodiments, the second label set (representative of one or more transactions conducted by the user with an entity associated with a training content item of a search query-content item record pair) is determined as the dominant label set, and the first label set (representative of a selection of a training content item by a user) is determined as a non-dominant label set.

In some embodiments, at step/operation 606, the predictive data analysis computing entity 106 selects an unlabeled search query-content item record pair associated with a training dataset and determines whether an event associated with the dominant label set has occurred with respect to the selected search query-content item record pair. In some embodiments, the training dataset is extracted from and/or generated based on activity data associated with the user. In some embodiments, the event associated with the dominant label set comprises a transaction conducted by the user with an entity associated with a training content item of the search query-content item record pair.

In some embodiments, a search query-content item record pair describes at least a portion of a training dataset comprising a search query and a content item record associated with the search query. According to various embodiments of the present disclosure, a machine learning model, such as a personalized re-ranking machine learning model, is trained on a training dataset comprising one or more labeled search query-content item record pairs.

In some embodiments, a content item record describes activity data associated with a user with respect to a training content item. For example, a content item record may comprise information extracted from search session data, such as search query/prefix, search results, or click/selection data, and/or transaction data comprising transactions of a user with one or more entities associated with a training content item within a given time window, such as 45 days.

According to various embodiments of the present disclosure, each of one or more search query-content item record pairs associated with the training dataset is assigned with a single label. In particular, a given search query-content item record pair may be assigned with a label based on an occurrence of an event associated with the dominant label set. In the event of a non-occurrence of the event associated with the dominant label set, a label may be selectively (e.g., randomly given a probability distribution over the plurality of label sets) assigned from any of the plurality of label sets. That is, labels that are rarely assigned may be diminished or otherwise trivialized by labels that are more commonly assigned (e.g., vanishing gradient). As such, the dominant label set is prioritized over other ones of the plurality of label sets to compensate for labels, such as labels in the dominant label set, that may be infrequently assigned due to fewer number of occurrences, thereby generating a more diverse set of training data.

In some embodiments, at step/operation 608, the predictive data analysis computing entity 106, responsive to an occurrence of the event associated with the dominant label set with respect to the search query-content item record pair, assigns a first label associated with the dominant label set to the search query-content item record pair. The first label assigned to the search query-content item record pair may comprise a representation of the occurrence of the event associated with the dominant label set. For example, the first label may be associated with a transaction conducted by the user with an entity associated with a training content item of the search query-content item record pair.

In some embodiments, at step/operation 610, the predictive data analysis computing entity 106, responsive to a non-occurrence of the event associated with the dominant label set with respect to the search query-content item record pair, assigns one or more stochastic labels from the plurality of label sets to one or more second search query-content item record pairs associated with the training dataset. The one or more stochastic labels may comprise a second label associated with the dominant label set, or one or more third labels associated with a non-dominant label set. The second label associated with the dominant label set may comprise a representation of the non-occurrence of the event associated with the dominant label set. For example, the second label may be associated with no transactions conducted by the user with an entity associated with the training content item of the search query-content item record pair. In some embodiments, the non-dominant label set comprises the first label set and the one or more third labels are representative of whether a user has selected a training content item. In some embodiments, assigning the one or more stochastic labels comprises randomly selecting the second label (e.g., with α probability) or the one or more third labels (e.g., with 1-α probability).

In some embodiments, at step/operation 612, the predictive data analysis computing entity 106 determines whether there are any more search query-content item record pairs in the dataset for labeling. If there are more search query-content item record pairs in the dataset for labeling, the process 600 returns to step/operation 606.

In some embodiments, if there are no more search query-content item record pairs in the dataset for labeling, at step/operation 614, the predictive data analysis computing entity 106 updates one or more parameters associated with a machine learning model based on the assignment(s) of labels from the plurality of label sets to the one or more search query-content item record pairs. In some embodiments, updating the one or more parameters comprises generating one or more content item feature vectors or one or more personalized feature vectors based on the first label and the one or more stochastic labels of the one or more search query-content item record pairs. According to various embodiments, the machine learning model comprises a transformer machine learning model configured to and/or used to generate a plurality of predictions for a plurality of suggestion content items based on the one or more parameters. In some embodiments, a plurality of rankings may be assigned to the plurality of suggestion content items based on the plurality of predictions. In some embodiments, one or more suggestions are generated, responsive to a search input received from a user, by selecting one or more of the plurality of suggestion content items based on the plurality of rankings.

According to various embodiments of the present disclosure, bias correction is performed to accommodate for one or more of exploitation biases, position bias, or selection bias in training data. In some embodiments, bias correction is performed during the training process of a machine learning model, such as a personalized re-ranking machine learning model, by modifying a training dataset.

Exploitation biases may occur with content items that have no clicks/selections or user interactions. For example, a personalized re-ranking machine learning model trained based on features associated with clicks/selections or user interactions may rank content items that are more frequently clicked/selected or interacted with higher than content items that are not frequently clicked/selected or interacted regardless of relevancy. As such, training data generated based on content items that are not associated with any click/selection or user interaction may not capture any information useful for training the personalized re-ranking machine learning model. Accordingly, an alternative ranking method may be used to provide a chance for new content items or no click/selection or interaction history to be ranked in higher ranking position and when significant amounts of content item feature vectors for training the personalized re-ranking machine learning model are missing (e.g., resulting in a model confidence score that is lower than a set threshold).

In some embodiments, responsive to determining that a training dataset comprises one or more search query-content item record pairs that are missing one or more content item feature vectors, one or more alternative rankings are assigned to one or more training content items associated with the one or more search query-content item record pairs. In some embodiments, the one or more alternative ranking may be based on one or more business metrics, such as cost, rating, quality, distance, or tiering, based on importance, preference, or priority of particular searches. In some embodiments, the one or more alternative rankings may comprise one or more initial rankings associated with the one or more training content items. In another embodiment, uncertainty-aware learning may be used to compensate for exploitation bias by applying Monte Carlo dropout or spectral-normalized neural Gaussian process (SNGP) to estimate uncertainty of predictions generated by a personalized re-ranking machine learning model (e.g., trained with content items comprising content item feature vectors that are missing) and further explore content items with high prediction uncertainty. In some embodiments, uncertainty-aware learning comprises (i) determining an uncertainty associated with one or more initial rankings associated with one or more training content items based on one or more Monte Carlo dropout or spectral-normalized neural Gaussian process, (ii) determining ones of the one or more training content items that are associated with one or more rankings comprising high uncertainty based on the uncertainty associated with the one or more initial rankings, and (iii) determining an alternative ranking for each of the ones of the one or more training content items. In yet another embodiment, initial rankings of the one or more training content items are used along with cherry picking of content item feature vectors with highest confidence scores (e.g., finding healthcare providers in specialty areas such as rare conditions or high volume specialties, such as primary care physicians). In some embodiments, assigning one or more alternative rankings to the one or more training content items comprises assigning one or more favorable rankings to ones of the one or more training content items that are associated with one or more content item feature vectors comprising highest confidence scores.

Position biases may occur with content items that are ranked and presented prominently or at the top of a list. For example, content items that are shown at the top of a search results list (e.g., on a search results page) are more likely to be clicked/selected regardless of relevance, and on the other hand, content items that are shown at the bottom of the search results list or on a next page may be less likely clicked/selected. As such, content items that are positioned in lower rank positions are less likely to be examined and clicked/selected by a user at a lower rate in spite of their actual relevance to a search query.

In some embodiments, updating one or more parameters associated with a machine learning model further comprises updating the one or more parameters based on a plurality of position embeddings associated with one or more training content items. In some embodiments, position bias may be accounted for in the position embeddings. In some embodiments, generating a position embedding for a training content item comprises (i) determining an examination probability of a given position and a relevance probability of a given training content item being relevant for the search input based on regression-based expectation-maximization of the search session data and (ii) generating a position bias correction for an initial ranking of the given training content item based on a position bias model, the examination probability, and the relevance probability.

In some embodiments, a position embedding comprises a position bias model. In some embodiments, a position bias model may comprise the following:

$$P ( C = 1 \vert q , d , k ) = P ( E = 1 \vert k ) * P ( R = 1 \vert q , d ) \qquad Equation 1$$

where P(C=1|q,d,k) is the probability of clicking document d shown at position k given query q, P(E=1|k) is the probability that position k is examined, and P(R=1|q,d) is the probability that document d is relevant to query q.

Selection biases may occur when lower ranked content items, due to display space limits, may not be given an opportunity (e.g., zero probability) of being observed/clicked by a user. For example, content items that are listed in a page other than a first search results page may never be observed (e.g., navigated to, seen, or clicked/selected by a user). In some embodiments, selection bias associated with one or more training content items may be corrected by (i) determining a probability of one or more training content items being observed based on a probit function, (ii) generating an inverse Mills ratio of the probability, and (iii) generating a selection bias correction for one or more initial rankings associated with the one or more training content items based on a control function comprising the inverse Mills ratio.

In some embodiments, an inverse Mills ratio for severity of selection bias, λ_{x,y,} of the probability of one or more training content items being observed, θZ, may calculated for every query x and content item y pair by:

$${λ}_{x , y} = \frac{ϕ ( θ {Z}_{x , y} )}{Φ ( θ {Z}_{x , y} )} \qquad Equation 2$$

where ϕ(θZ_{x,y}) may represent a ratio of standard normal density (or probability density function) and Φ(θZ_{x,y}) may represent a standard normal cumulative distribution function.

Selection bias may be corrected by obtaining an unbiased estimate of click probability by controlling \hat{λ}_{x,y} based on the following:

$${c}_{x , y} = {α}^{unbiased} {F}_{x , y} + σ {\hat{λ}}_{x , y} ( \hat{θ} {Z}_{x , y} ) + {ϵ}_{x , y} \qquad Equation 3$$

where c_{x,y} may represent whether a document y is selected (e.g., clicked) under query x for each query-document pair, a^{unbiased} may represent a feature weights estimator that is unbiased, F_{x,y} may represent features of query-document pair, and ϵ_{x,y} may represent a normally distributed error term.

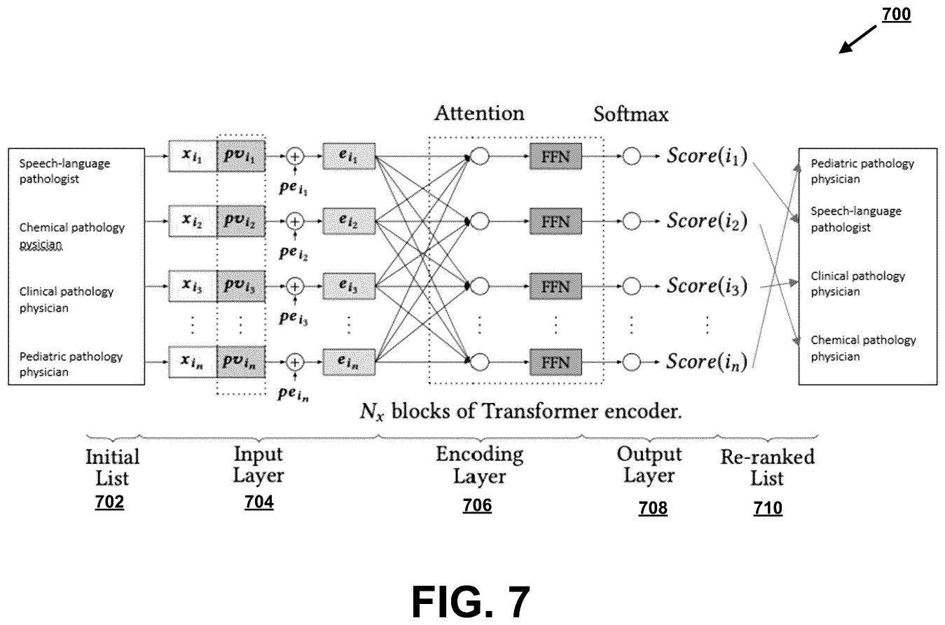

FIG. 7 is an operational example of a personalized re-ranking machine learning model architecture 700 in accordance with some embodiments of the present disclosure.

As depicted in FIG. 7, personalized re-ranking machine learning model architecture 700 comprises an initial list 702, an input layer 704, an encoding layer 706, an output layer 708, and a re-ranked list 710.

The initial list 702 may comprise a list of suggested keywords comprising a plurality of keywords associated with a respective plurality of initial rankings.

The input layer 704 may be configured to generate (i) keyword feature vectors associated with the initial list 702 and (ii) personalized feature vectors associated with a user.

The encoding layer 706 may comprise Nₓ blocks of transformer encoders comprising one or more attention mechanisms and feedforward networks configured to generate one or more predictions for the initial list 702 (e.g., a plurality of keywords) based on the keyword feature vectors and the personalized feature vectors from the input layer 704.

The output layer 708 may be configured to generate one or more probability scores of whether a content item will be clicked/selected (and/or transacted with) by a user based on the predictions generated using the encoding layer 706. The output layer 708 may comprise an activation function, such as Softmax to normalize prediction output for generating the one or more probability scores.

Re-ranked list 710 may comprise a modification of initial list 702 based on the one or more probability scores. For example, one or more keywords in the initial list 702 may be assigned new rankings based on the one or more probability scores and re-ordered based on the new rankings to generate the re-ranked list 710.

Accordingly, as described above, various embodiments of the present disclosure make important technical contributions to improving predictive accuracy of predictive machine learning models used in generating content item suggestions by generating predictions for a plurality of content items in lists of suggestions based on a plurality of content item feature vectors associated with the plurality of content items and one or more personalized feature vectors of a specific user. This approach improves training data quality and training efficiency of training predictive machine learning models. It is well-understood in the relevant art that there is typically a bottleneck of predictive accuracy due to training data quality. Thus, the challenge is to prepare training data with application relevant and reliable features leading to practical predictive accuracy through innovative machine learning model architectures. Accordingly, techniques that improve predictive accuracy without harming training speed, such as the techniques described herein, enable improving training data quality. In doing so, the techniques described herein improve efficiency and quality of preparing data feeding to predictive machine learning models, thus reducing the number of computational operations needed and/or the amount of training data entries needed to train predictive machine learning models.

Some techniques of the present disclosure enable the generation of prediction outputs that may be used to assign rankings of a plurality of content items that may be used for providing content item suggestions. The techniques of the present disclosure may be used, applied, and/or otherwise leveraged to generate content item suggestions, which may help in the identification of relevant content items matching an intent of a user. A personalized re-ranking machine learning model of the present disclosure may be leveraged to rank a list of suggestion that improve the performance of a computing system (e.g., a computer itself, etc.) with respect to various predictive actions performed by the predictive data analysis computing entity 106, such as for the matching of content items to search session activities of a user.

In some examples, the content item suggestions may include predictive actions that may be based on a prediction domain. A prediction domain may include any environment in which computing systems may be applied to achieve real-word insights, such as predictions (e.g., predictive intents), and initiate the performance of computing tasks, such as predictive actions to act on the real-world insights. These predictive actions may cause real-world changes, for example, by controlling a hardware component, providing alerts, interactive actions, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method comprising: receiving, by one or more processors, a list of suggestions that comprises a plurality of content items associated with a respective plurality of entities; generating, by the one or more processors, a plurality of content item feature vectors associated with the plurality of content items; generating, by the one or more processors, one or more personalized feature vectors based on activity data associated with a user; generating, by the one or more processors, a plurality of predictions on the plurality of content items based on the plurality of content item feature vectors and the one or more personalized feature vectors; assigning, by the one or more processors, a plurality of rankings to the plurality of content items based on the plurality of predictions; and generating, by the one or more processors, one or more suggestions, responsive to a search input received from the user, by selecting one or more of the plurality of content items based on the plurality of rankings.

Example 2. The computer-implemented method of any of the preceding examples further comprising generating the plurality of predictions by using a personalized re-ranking machine learning model comprising a transformer machine learning model.

Example 3. The computer-implemented method of any of the preceding examples, wherein the plurality of predictions comprise a respective plurality of probabilities of the user selecting the plurality of content items.

Example 4. The computer-implemented method of any of the preceding examples further comprising generating the plurality of predictions based on a plurality of position embeddings associated with the list of suggestions.

Example 5. The computer-implemented method of any of the preceding examples, wherein the activity data comprises at least one of search session data or transaction data.

Example 6. The computer-implemented method of any of the preceding examples further comprising: generating training data based on the activity data; and training the personalized re-ranking machine learning model based on the training data.

Example 7. The computer-implemented method of any of the preceding examples, wherein generating the training data further comprises labeling one or more search query-content item record pairs based on (i) occurrence of selection of one or more training content items, or (ii) transaction data comprising the one or more training content items.

Example 8. The computer-implemented method of any of the preceding examples, wherein the plurality of content items are associated with a respective plurality of initial rankings, and assigning the plurality of rankings further comprises re-ranking the plurality of content items by modifying the plurality of initial rankings based on the plurality of predictions.

Example 9. A computing system comprising memory and one or more processors communicatively coupled to the memory, the one or more processors configured to: receive a list of suggestions that comprises a plurality of content items associated with a respective plurality of entities; generate a plurality of content item feature vectors associated with the plurality of content items; generate one or more personalized feature vectors based on activity data associated with a user; generate a plurality of predictions on the plurality of content items based on the plurality of content item feature vectors and the one or more personalized feature vectors; assign a plurality of rankings to the plurality of content items based on the plurality of predictions; and generate one or more suggestions, responsive to a search input received from the user, by selecting one or more of the plurality of content items based on the plurality of rankings.

Example 10. The computing system of any of the preceding examples, wherein the one or more processors are further configured to generate the plurality of predictions by using a personalized re-ranking machine learning model comprising a transformer machine learning model.

Example 11. The computing system of any of the preceding examples, wherein the plurality of predictions comprise a respective plurality of probabilities of the user selecting the plurality of content items.

Example 12. The computing system of any of the preceding examples, wherein the one or more processors are further configured to generate the plurality of predictions based on a plurality of position embeddings associated with the list of suggestions.

Example 13. The computing system of any of the preceding examples, wherein the activity data comprises at least one of search session data or transaction data.

Example 14. The computing system of any of the preceding examples, wherein the one or more processors are further configured to: generate training data based on the activity data; and train the personalized re-ranking machine learning model based on the training data.

Example 15. The computing system of any of the preceding examples, wherein the one or more processors are further configured to generate the training data by labeling one or more search query-content item record pairs based on (i) occurrence of selection of one or more training content items, or (ii) transaction data comprising the one or more training content items.

Example 16. The computing system of any of the preceding examples, wherein the plurality of content items are associated with a respective plurality of initial rankings, and the one or more processors are further configured to assign the plurality of rankings further comprises re-ranking the plurality of content items by modifying the plurality of initial rankings based on the plurality of predictions.

Example 17. One or more non-transitory computer-readable storage media including instructions that, when executed by one or more processors, cause the one or more processors to: receive a list of suggestions that comprises a plurality of content items associated with a respective plurality of entities; generate a plurality of content item feature vectors associated with the plurality of content items; generate one or more personalized feature vectors based on activity data associated with a user; generate a plurality of predictions on the plurality of content items based on the plurality of content item feature vectors and the one or more personalized feature vectors; assign a plurality of rankings to the plurality of content items based on the plurality of predictions; and generate one or more suggestions, responsive to a search input received from the user, by selecting one or more of the plurality of content items based on the plurality of rankings.

Example 18. The one or more non-transitory computer-readable storage media of any of the preceding examples further including instructions that, when executed by the one or more processors, cause the one or more processors to generate the plurality of predictions by using a personalized re-ranking machine learning model comprising a transformer machine learning model.

Example 19. The one or more non-transitory computer-readable storage media of any of the preceding examples, wherein the plurality of predictions comprise a respective plurality of probabilities of the user selecting the plurality of content items.

Example 20. The one or more non-transitory computer-readable storage media of any of the preceding examples further including instructions that, when executed by the one or more processors, cause the one or more processors to generate the plurality of predictions based on a plurality of position embeddings associated with the list of suggestions.

Example 21. The one or more non-transitory computer-readable storage media of any of the preceding examples, wherein the activity data comprises at least one of search session data or transaction data.

Example 22. The one or more non-transitory computer-readable storage media of any of the preceding examples further including instructions that, when executed by the one or more processors, cause the one or more processors to generate training data based on the activity data; and train the personalized re-ranking machine learning model based on the training data.

Example 23. The one or more non-transitory computer-readable storage media of any of the preceding examples further including instructions that, when executed by the one or more processors, cause the one or more processors to generate the training data by labeling one or more search query-content item record pairs based on (i) occurrence of selection of one or more training content items, or (ii) transaction data comprising the one or more training content items.

Example 24. The one or more non-transitory computer-readable storage media of any of the preceding examples, wherein the plurality of content items are associated with a respective plurality of initial rankings, and further including instructions that, when executed by the one or more processors, cause the one or more processors to assign the plurality of rankings further comprises re-ranking the plurality of content items by modifying the plurality of initial rankings based on the plurality of predictions.

1. A computer-implemented method comprising:
receiving, by one or more processors, a list of suggestions that comprises a plurality of content items associated with a plurality of entities;
generating, by the one or more processors, a plurality of content item feature vectors associated with the plurality of content items;
generating, by the one or more processors, one or more personalized feature vectors based on activity data associated with a user;
generating, by the one or more processors, a plurality of predictions for the plurality of content items based on the plurality of content item feature vectors and the one or more personalized feature vectors;
assigning, by the one or more processors, a plurality of rankings to the plurality of content items based on the plurality of predictions; and
generating, by the one or more processors, one or more suggestions, responsive to a search input received from the user, by selecting one or more of the plurality of content items based on the plurality of rankings.

2. The computer-implemented method of claim 1, wherein the plurality of predictions comprises a respective plurality of probabilities of the user selecting the plurality of content items.

3. The computer-implemented method of claim 1 further comprising generating the plurality of predictions based on a plurality of position embeddings associated with the list of suggestions.

4. The computer-implemented method of claim 1, wherein the activity data comprises at least one of search session data or transaction data.

5. The computer-implemented method of claim 1 further comprising generating the plurality of predictions by using a personalized re-ranking machine learning model comprising a transformer machine learning model.

6. The computer-implemented method of claim 5 further comprising:
generating training data based on the activity data; and
training the personalized re-ranking machine learning model based on the training data.

7. The computer-implemented method of claim 6, wherein generating the training data further comprises labeling one or more search query-content item record pairs based on (i) an occurrence of a selection of one or more training content items, or (ii) transaction data comprising the one or more training content items.

8. The computer-implemented method of claim 1, wherein the plurality of content items is associated with a respective plurality of initial rankings, and assigning the plurality of rankings further comprises re-ranking the plurality of content items by modifying the plurality of initial rankings based on the plurality of predictions.

9. A computing system comprising memory and one or more processors communicatively coupled to the memory, the one or more processors configured to:
receive a list of suggestions that comprises a plurality of content items associated with a plurality of entities;
generate a plurality of content item feature vectors associated with the plurality of content items;
generate one or more personalized feature vectors based on activity data associated with a user;
generate a plurality of predictions for the plurality of content items based on the plurality of content item feature vectors and the one or more personalized feature vectors;
assign a plurality of rankings to the plurality of content items based on the plurality of predictions; and
generate one or more suggestions, responsive to a search input received from the user, by selecting one or more of the plurality of content items based on the plurality of rankings.

10. The computing system of claim 9, wherein the one or more processors are further configured to generate the plurality of predictions based on a plurality of position embeddings associated with the list of suggestions.

11. The computing system of claim 9, wherein the activity data comprises at least one of search session data or transaction data.

12. The computing system of claim 9, wherein the one or more processors are further configured to generate the plurality of predictions by using a personalized re-ranking machine learning model comprising a transformer machine learning model.

13. The computing system of claim 12, wherein the one or more processors are further configured to:
generate training data based on the activity data; and
train the personalized re-ranking machine learning model based on the training data.

14. The computing system of claim 13, wherein the one or more processors are further configured to generate the training data by labeling one or more search query-content item record pairs based on (i) an occurrence of a selection of one or more training content items, or (ii) transaction data comprising the one or more training content items.

15. The computing system of claim 9, wherein the plurality of content items is associated with a respective plurality of initial rankings, and the one or more processors are further configured to re-rank the plurality of content items by modifying the plurality of initial rankings based on the plurality of predictions.

16. One or more non-transitory computer-readable storage media including instructions that, when executed by one or more processors, cause the one or more processors to:
receive a list of suggestions that comprises a plurality of content items associated with a plurality of entities;
generate a plurality of content item feature vectors associated with the plurality of content items;
generate one or more personalized feature vectors based on activity data associated with a user;
generate a plurality of predictions for the plurality of content items based on the plurality of content item feature vectors and the one or more personalized feature vectors;
assign a plurality of rankings to the plurality of content items based on the plurality of predictions; and
generate one or more suggestions, responsive to a search input received from the user, by selecting one or more of the plurality of content items based on the plurality of rankings.

17. The one or more non-transitory computer-readable storage media of claim 16 further including instructions that, when executed by the one or more processors, cause the one or more processors to generate the plurality of predictions by using a personalized re-ranking machine learning model comprising a transformer machine learning model.

18. The one or more non-transitory computer-readable storage media of claim 16 further including instructions that, when executed by the one or more processors, cause the one or more processors to:
generate training data based on the activity data; and
train a personalized re-ranking machine learning model based on the training data.

19. The one or more non-transitory computer-readable storage media of claim 18 further including instructions that, when executed by the one or more processors, cause the one or more processors to generate the training data by labeling one or more search query-content item record pairs based on (i) an occurrence of a selection of one or more training content items, or (ii) transaction data comprising the one or more training content items.

20. The one or more non-transitory computer-readable storage media of claim 16, wherein the plurality of content items is associated with a respective plurality of initial rankings, and the one or more processors are further configured to re-rank the plurality of content items by modifying the plurality of initial rankings based on the plurality of predictions.
